(19) United States
(12) Patent Application Publication
(10) Pub. No.: US 2014/0182554 A1
(43) Pub. Date: Jul. 3, 2014

(54) INJECTION SYSTEM FOR COLD START IMPROVEMENT OF FLEXIBLE-FUEL VEHICLE AND METHOD OF CONTROLLING THE SAME

(71) Applicant: HYUNDAI MOTOR COMPANY, Seoul (KR)

(72) Inventors: Hyung Ju Lee, Seoul (KR); Min Kyu Shin, Seongnam-si (KR)

(73) Assignee: Hyundai Motor Company, Seoul (KR)

(21) Appl. No.: 13/856,771

(22) Filed: Apr. 4, 2013

(30) Foreign Application Priority Data
Dec. 27, 2012 (KR) 10-2012-0154477

(51) Int. Cl. F02M 61/14

(52) U.S. Cl. CPC F02M 61/14
USPC 123/470

(57) ABSTRACT

An injection system for cold start improvement of a flexible-fuel vehicle (FFV), may include a first injector installed in an intake port, and a second injector installed in the intake port in which the first injector may be installed and having a built-in heater, wherein the first injector and the second injector may be positioned upstream of intake valves.

### CROSS-REFERENCE TO RELATED APPLICATION

The present application claims priority to Korean Patent Application No. 10-2012-0154477, filed on Dec. 27, 2012, the entire contents of which is incorporated herein for all purposes by this reference.

### BACKGROUND OF THE INVENTION

1. Field of the Invention

The present invention relates, generally, to an injection system for cold start of a flexible-fuel vehicle (FFV) and a method of controlling the same and, more particularly, to technology capable of improving a cold start characteristic of an FFV using ethanol as a primary fuel.

2. Description of Related Art

Conventionally, flexible-fuel vehicles (FFVs) designed to mainly use ethanol do not ensure a smooth start characteristic when only using ethanol as a primary fuel in cold weather. As such, these FFVs are equipped with a separate auxiliary fuel tank for holding a small quantity of gasoline, and the gasoline held in this tank is injected downstream of a throttle valve in the event of a cold start, thereby improving a cold start characteristic of the engine.

FIG. 1 shows a configuration of a fuel supply system of a conventional FFV. The fuel supply system includes a main injector 502 supplied with primary fuel from a main fuel tank 500, and an auxiliary injector 506 injecting gasoline supplied from a separate auxiliary fuel tank 504, and is configured so that the gasoline supplied to the auxiliary injector 506 is controlled by a cold start solenoid valve 508.

In the fuel supply system of the conventional FFV, since the auxiliary fuel tank 504 is typically installed in an engine space, there is a high possibility of the fuel in the auxiliary fuel tank 504 causing a fire in the event that the FFV vehicle is involved in a collision or accident. Further, there is inconvenience in that the gasoline should be supplied separately, and there is a problem in that a cost is increased.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an injection system for cold start improvement of a flexible-fuel vehicle (FFV) and a method of controlling the same, in which fuel is supplied to an engine so as to allow the engine of the FFV to be smoothly started in a cold start condition without an auxiliary fuel tank for separately storing fuel used to assist cold start such as gasoline, thereby improving a cold start characteristic of the FFV, and removing parts such as an auxiliary fuel tank to reduce a cost of the FFV.

In order to achieve the above object, according to an aspect of the present invention, there is provided an injection system for cold start improvement of a flexible-fuel vehicle (FFV), which may include a first injector installed in an intake port, and a second injector installed in the intake port in which the first injector is installed and having a built-in heater.

According to another aspect of the present invention, there is provided a method of controlling an injection system for cold start improvement of an FFV, which may include a cold start determining process of determining whether or not there is a cold start condition, a heater driving process of, as a result of performing the cold start determining process, if it is determined that there is a cold start condition, of first and second injectors installed in an intake port communicating with one combustion chamber, driving a heater mounted in the second injector, and a heated-fuel injecting process of controlling fuel heated by the heater of the second injector so as to be injected in an atomized state.

According to the present invention, fuel is supplied to an engine so as to allow the engine to be smoothly started in a cold start condition of the FFV without an auxiliary fuel tank for separately storing fuel used to assist cold start such as gasoline. A cold start characteristic of the FFV can be improved, and parts such as an auxiliary fuel tank can be removed to reduce a cost of the FFV.

loom The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view describing a conventional fuel supply system of a flexible-fuel vehicle (FFV).

FIG. 2 shows an intake port portion of an engine having a duel injector to which an injection system for cold start improvement of an FFV in accordance with an exemplary embodiment of the present invention is applied.

FIG. 3 is a view describing a configuration of the injection system for cold start improvement of an FFV in accordance with the exemplary embodiment of the present invention.

FIG. 4 is a flow chart showing a method of controlling the injection system for cold start improvement of an FFV in accordance with the exemplary embodiment of the present invention.

FIG. 5 is a view describing an operation of the injection system for cold start improvement of an FFV in accordance with the exemplary embodiment of the present invention in a condition other than a cold start condition.

FIG. 6 is a view describing an operation of the injection system for cold start improvement of an FFV in accordance with the exemplary embodiment of the present invention in the cold start condition.

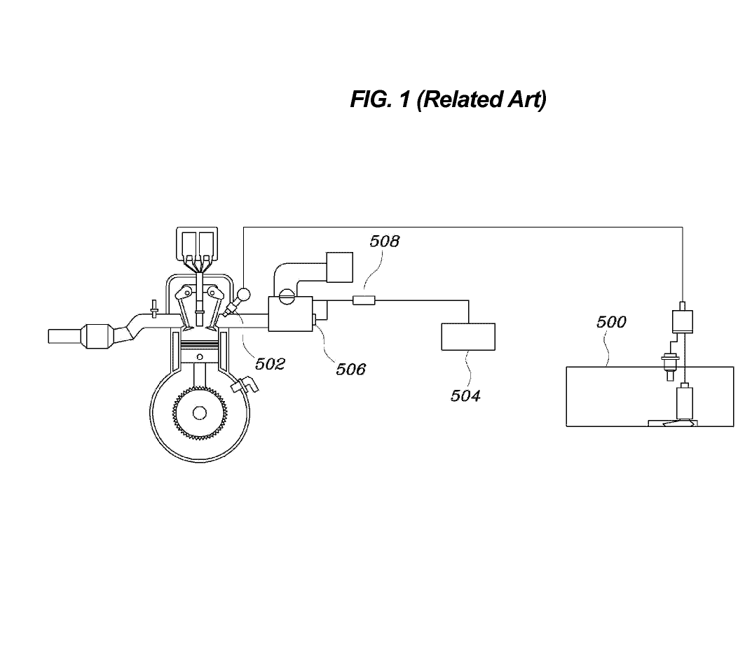

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, an exemplary embodiment of the present invention will be described in detail with reference to the accompanying drawings.

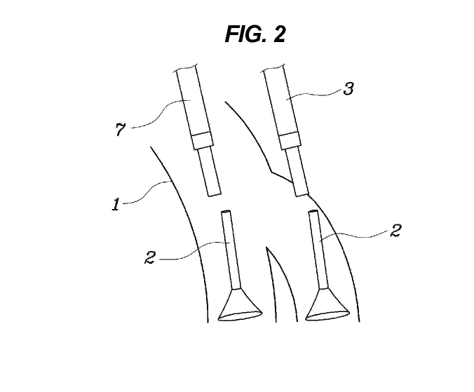

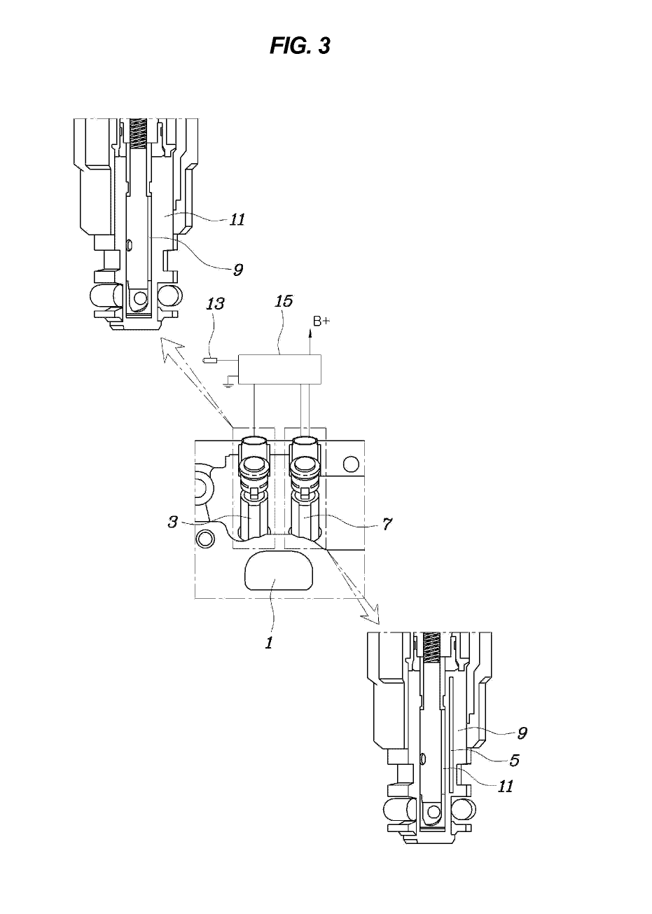

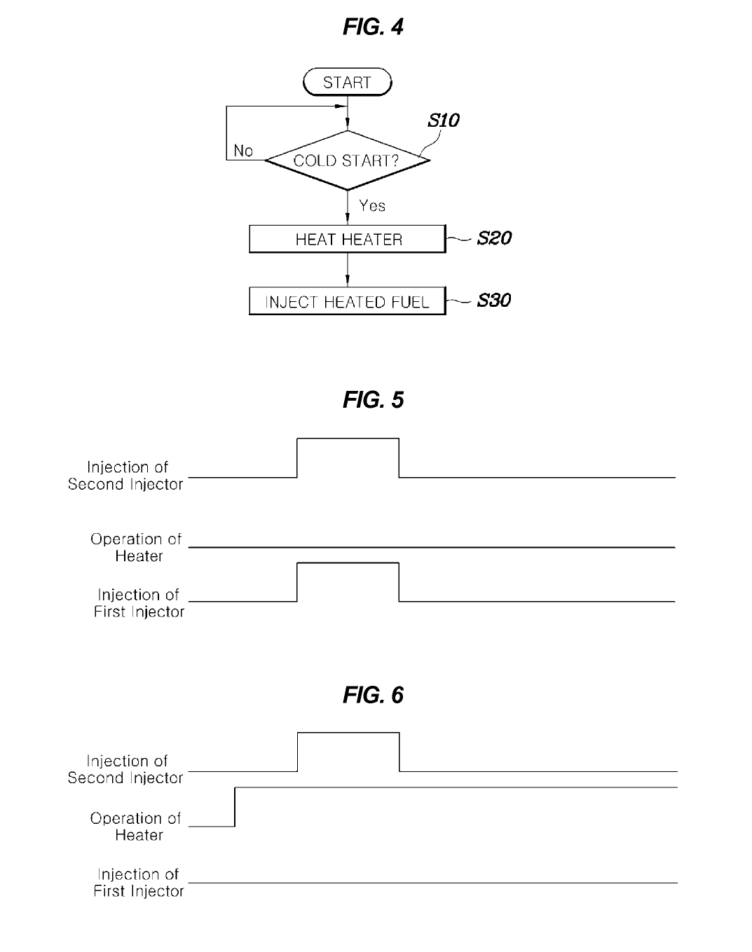

Referring to FIGS. 2 and 3, an injection system for cold start improvement of a flexible-fuel vehicle (FFV) in accordance with an exemplary embodiment of the present invention includes a first injector 3 installed in an intake port 1, and a second injector 7 installed in the intake port 1 in which the first injector 3 is installed and having a built-in heater 5.

In detail, as shown in FIG. 2, the injection system constitutes an engine having a dual injector injecting fuel supplied to one combustion chamber into upstream of intake valves 2. As described above, the first injector 3 of the dual injector is not equipped with a separate heater, and only the second injector 7 is equipped with the heater 5. In the event of cold start, the fuel injected by the second injector 7 is heated by the heater 5. Thereby, the engine is smoothly started. Thus, an auxiliary fuel tank for separately storing cold-starting fuel such as gasoline as in the related art is not provided.

As shown in FIG. 3, the heater 5 is disposed inside an injector body 9 adjacent to a fuel passage 11 of the second injector 7 in a lengthwise direction of the fuel passage 11. This is favorable for heating the fuel.

Further, in the exemplary embodiment of the present invention, the injection system may further include a temperature sensor 13 for detecting a cold start condition, and a controller 15 for receiving a signal from the temperature sensor 13, driving the heater 5 of the second injector 7 when it is determined that the cold start condition is detected, and controlling only the second injector 7 so as to inject the fuel. A smooth start characteristic can be secured in the cold start condition of the engine without a separate auxiliary fuel supply system.

Here, the temperature sensor 13 may use a coolant temperature sensor measuring a temperature of a coolant for the engine or an atmospheric temperature sensor measuring a temperature of the atmosphere.

A method of controlling the injection system as described above includes a cold start determining process S10 of determining whether there is a cold start condition, a heater driving process S20 of, as a result of performing the cold start determining process S10, if it is determined that there is the cold start condition, of first and second injectors 3 and 7 installed in an intake port 1 communicating with one combustion chamber, driving a heater 5 mounted in the second injector 7, and a heated-fuel injecting process S30 of controlling fuel heated by the heater 5 of the second injector 7 to be injected in an atomized state.

That is, in the cold start determining process S10, it is determined by a temperature of a coolant or atmosphere whether or not there is the cold start of the engine. In the heater driving process S20, if it is determined that there is a cold start of the engine, the heater 5 of the second injector 7 is driven to heat the fuel, and the fuel heated by the heater 5 is injected so as to be smoothly started.

FIG. 5 shows an operation of the injection system in a condition other than a cold start condition. The heater 5 is not operated, and the fuel required from a corresponding combustion chamber is split and injected by the first injector 3 and the second injector 7.

FIG. 6 shows an operation of the injection system in a cold start condition in comparison with FIG. 5. The heater 5 is operated, and only the second injector 7 in which the heater 5 is mounted injects the fuel, whereas the first injector 3 does not inject the fuel.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An injection system for cold start improvement of a flexible-fuel vehicle (FFV), comprising:
a first injector installed in an intake port; and
a second injector installed in the intake port in which the first injector is installed and having a built-in heater,
wherein the first injector and the second injector is positioned upstream of intake valves.

2. The injection system according to claim 1,
wherein the heater is disposed inside an injector body of the second injector, and
wherein the heater is adjacent to a fuel passage formed in the second injector in a lengthwise direction of the second injector.

3. The injection system according to claim 1, further comprising:
a temperature sensor detecting a cold start condition; and
a controller receiving a signal from the temperature sensor, driving the heater of the second injector when it is determined that the cold start condition is detected, and controlling the second injector so as to inject a fuel into the intake port.

4. The injection system according to claim 3, wherein the temperature sensor measures a temperature of a coolant for an engine.

5. The injection system according to claim 3, wherein the temperature sensor measures a temperature of an atmosphere.

6. An engine having the injection system according to claim 1.

7. An injector for a dual injector engine for cold start improvement of a flexible-fuel vehicle (FFV), which is installed in an intake port communicating with one combustion chamber shared in common with another injector, and has a heater mounted therein around an internal fuel passage formed therein.

8. A method of controlling an injection system for cold start improvement of a flexible-fuel vehicle (FFV), comprising:
determining whether or not a cold start condition is detected;
driving a heater mounted in a second injector of a first injector and the second injector installed in an intake port communicating with one combustion chamber when it is determined that there is the cold start condition; and
controlling fuel heated by the heater of the second injector so as to be injected into the one combustion chamber in an atomized state.

9. The method according to claim 8, wherein the controlling the fuel heated by the heater of the second injector includes controlling the second injector so that the second injector injects the fuel into the one combustion chamber.

10. The method according to claim 9, wherein the controlling the fuel heated by the heater of the second injector includes controlling the first injector so that the first injector does not inject the fuel into the one combustion chamber.
